(19) United States
(12) Patent Application Publication
(10) Pub. No.: US 2024/0389496 A1
(43) Pub. Date: Nov. 28, 2024

(54) TREATMENT APPLICATORS

(71) Applicant: MONSANTO TECHNOLOGY LLC, Saint Louis, MO (US)

(72) Inventors: Paul Lee MISKELL, Collinsville, IL (US); Andrew David THIELEN, Scranton, IA (US); Laura WHITTLE, Saint Louis, MO (US); Charles WOLFERSBERGER, Saint Louis, MO (US)

(21) Appl. No.: 18/671,866

(22) Filed: May 22, 2024

Related U.S. Application Data
(60) Provisional application No. 63/468,499, filed on May 23, 2023.

(51) Int. Cl. A01C 7/06; A01G 7/06

(52) U.S. Cl. CPC A01C 7/06; A01G 7/06

(57) ABSTRACT

Treatment assemblies and systems including treatment assemblies are provided. One example treatment assembly includes an inlet configured to receive a treatment product, an outlet, and at least one rotatable wheel. The at least one rotatable wheel includes a base having an outer circumferential surface, and tabs extending away from the outer circumferential surface of the base. The tabs define receptacles each configured to receive a portion of the treatment product from the inlet as the wheel rotates. The at least one rotatable wheel is configured to transport the portion of the treatment product from the inlet and deliver the portion of the treatment product to the outlet. The outlet is configured, then, to dispense the portion of the treatment product to a field.

### CROSS-REFERENCE TO RELATED APPLICATION

This application claims the benefit of, and priority to, U.S. Provisional Application No. 63/468,499, filed on May 23, 2023. The entire disclosure of the above-referenced application is incorporated herein by reference.

### FIELD

The present disclosure generally relates to treatment applicators (or applicator assemblies, or metering devices, etc.) for use in applying treatment products, for example, to seeds in furrows (e.g., adjacent to the seeds as the seeds are placed (e.g., planted, etc.) in the furrows by planters, etc.), to soil (e.g., as a soil treatment independent of planting seeds in the soil, etc.) and methods relating thereto.

### BACKGROUND

This section provides background information related to the present disclosure which is not necessarily prior art.

Planters are often used to plant seeds in fields. In doing so, the planters may include seed meters for dispensing the seeds from storage units into furrows created by the planters in the fields. Once the seeds are planted, or even before the seeds are planted, treatments may be applied to the fields to help facilitate growth of the seeds into plants.

### SUMMARY

This section provides a general summary of the disclosure and is not a comprehensive disclosure of its full scope or all of its features.

Example embodiments of the present disclosure generally relate to assemblies and/or systems (e.g., metering assemblies and/or metering systems, etc.) for dispensing treatment products (e.g., into a field, etc.). In some example embodiments, such an assembly and/or system generally includes an inlet configured to receive a treatment product, an outlet configured to dispense the treatment product into a field (e.g., onto (or into) soil in the field, into a furrow formed in the field while planting seeds, etc.), and at least one rotatable wheel coupled between the inlet and the outlet. The at least one rotatable wheel generally includes a base having an outer circumferential surface, and tabs spaced apart circumferentially from each other and extending away from the outer circumferential surface of the base. The tabs define receptacles therebetween. Each receptacle is configured to receive a portion of the treatment product from the inlet as the wheel rotates. The at least one rotatable wheel is configured to transport the portion of the treatment product from the inlet and deliver the portion of the treatment product to the outlet. The outlet is configured to dispense the portion of the treatment product to the field (e.g., to the soil in the field, into the furrow adjacent to at least one seed, etc.). In other example embodiments, the assembly may include multiple rotatable wheels. Moreover, in example embodiments, the assembly may be used with/via (e.g., may be moved through the field by, etc.) (e.g., may be coupled to, etc.) a suitable agricultural machine (e.g., a planter, a tractor, etc.).

Example embodiments of the present disclosure also generally relate to methods of operating a treatment applicator to dispense treatment products in a field, where the seed treatment applicator includes at least one wheel defining a plurality of receptacles. In some example embodiments, such a method generally includes receiving, via an inlet, a treatment product in individual ones of the plurality of receptacles while the at least one wheel is rotating; controlling rotation of the at least one wheel to transport the treatment product in the individual ones of the plurality of receptacles to an outlet located away from the inlet; and delivering the treatment product in the individual ones of the plurality of receptacles to the outlet, thereby dispensing the treatment product in the field (e.g., to soil in the field, to a furrow formed by a planter and adjacent to seeds while the planter plants the seeds, etc.).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is an exploded perspective view of an example embodiment of a treatment assembly including one or more aspects of the present disclosure, for use in dispensing a treatment product to seeds as the seeds are planted by a planter, to soil (e.g., independent of planting seeds in the soil, in connection with planting seeds in the soil, etc.);

FIG. 2 is a front perspective view of a treatment applicator (e.g., a metering device, etc.) included in the treatment assembly of FIG. 1;

FIG. 3 is a rear perspective view of the treatment applicator of FIG. 2;

FIG. 4 is a fragmentary perspective view of an interior portion of the treatment applicator of FIG. 2;

FIG. 5 is a fragmentary perspective view of another interior portion of the treatment applicator of FIG. 2;

FIG. 6 is an exploded perspective view of the treatment applicator of FIG. 2;

FIG. 7 is an exploded perspective view of another example embodiment of a treatment assembly including one or more aspects of the present disclosure, for use in dispensing a treatment product to seeds as the seeds are planted by a planter, to soil (e.g., independent of planting seeds in the soil, in connection with planting seeds in the soil, etc.);

FIG. 8 is a perspective view of a treatment applicator (e.g., a metering wheel, etc.) included in the treatment assembly of FIG. 7;

FIG. 9 is an exploded perspective view of the treatment applicator of FIG. 8;

FIG. 10 is a perspective view of an example embodiment of a treatment system including one or more aspects of the present disclosure, for use with a planter to dispense a seed treatment product to seeds, using the seed treatment assembly of FIG. 1 or the seed treatment assembly of FIG. 7, as the seeds are planted by the planter;

FIG. 11 is a perspective view of another example embodiment of a treatment system including one or more aspects of the present disclosure, for use with a planter to dispense a seed treatment product to seeds, to soil, etc., using the treatment assembly of FIG. 1 or the treatment assembly of FIG. 7, for example, as the seeds are planted by the planter, independent of planting seeds, etc.;

FIG. 12 is a perspective view of an example embodiment of a planter including one or more aspects of the present disclosure and configured to plant seeds in a field;

FIG. 13 is a perspective view of an example embodiment of a planting unit of the planter of FIG. 12, where the planting unit includes the treatment system of FIG. 10 for use in dispensing a treatment product to the seeds as the seeds are planted by the planter in the field, or directly to the soil independent of planting seeds, etc.;

FIG. 14 is a rear view of the planting unit of FIG. 13; and

FIG. 15 is an enlarged side view of another example embodiment of a planting unit, which may be used in the planter of FIG. 12.

Corresponding reference numerals indicate corresponding parts throughout the several views of the drawings.

### DETAILED DESCRIPTION

Planters are often used to plant seeds in fields. For example, planters create furrows in the fields, deposit seeds into the furrows using seed meters, and then close the furrows to cover the planted seeds. Sometimes, it may be desirable to apply seed treatments such as microbials, insecticides, and inoculum materials in the furrows while planting the seeds. However, the applied seed treatments are often located/placed too far from the planted seeds to maximum the effectiveness of the treatments and are not designed for plot work (e.g., conventional systems are not able to prescriptively apply the seed treatments, etc.).

Uniquely, the seed treatment applicators, assemblies, and/or systems (and/or methods) herein utilize applicators (e.g., metering devices, etc.) coupled directly to the planters, adjacent the seed meters of the planters, to dispense seed treatment products directly into the furrows created by the planters adjacent the deposited seeds. In this manner, the seed treatment applicators, assemblies, and/or systems (and/or methods) may prescriptively and accurately apply the seed treatment products while the seeds are being planted. As such, the seed treatment products are positioned in generally close proximity to the seeds and therefore may be more effective in providing desired treatments (e.g., dry granular products, other products, etc.) to the planted seeds within the furrows (e.g., microbial treatments, insecticide treatments, inoculum treatments, etc.).

Example embodiments will now be described more fully with reference to the accompanying drawings. The description and specific examples included herein are intended for purposes of illustration only and are not intended to limit the scope of the present disclosure.

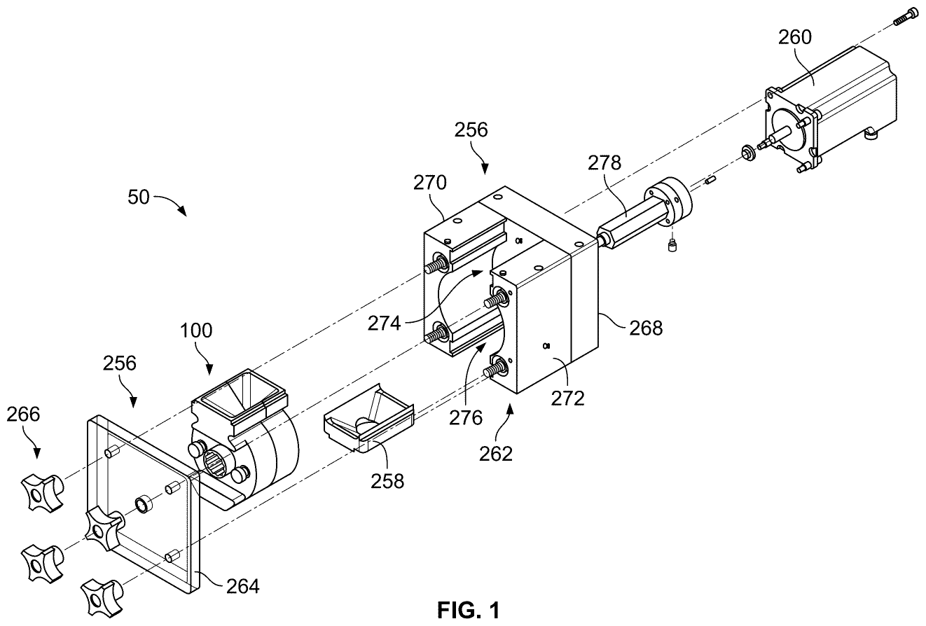

FIGS. 1-6 illustrate an example embodiment of a treatment assembly 50 including one or more aspects of the present disclosure. As explained herein, the treatment assembly 50 may be included in a treatment system (e.g., treatment system 1000, treatment system 1100, etc.) connected to a planter (e.g., planter 1200, etc.) or other agricultural machine for use in applying a treatment product to seeds as the seeds are planted by the planter, to soil as the planter or other agricultural machine traverses a field (e.g., independent of planting seeds in the soil or in connection with planting seeds in the soil, etc.).

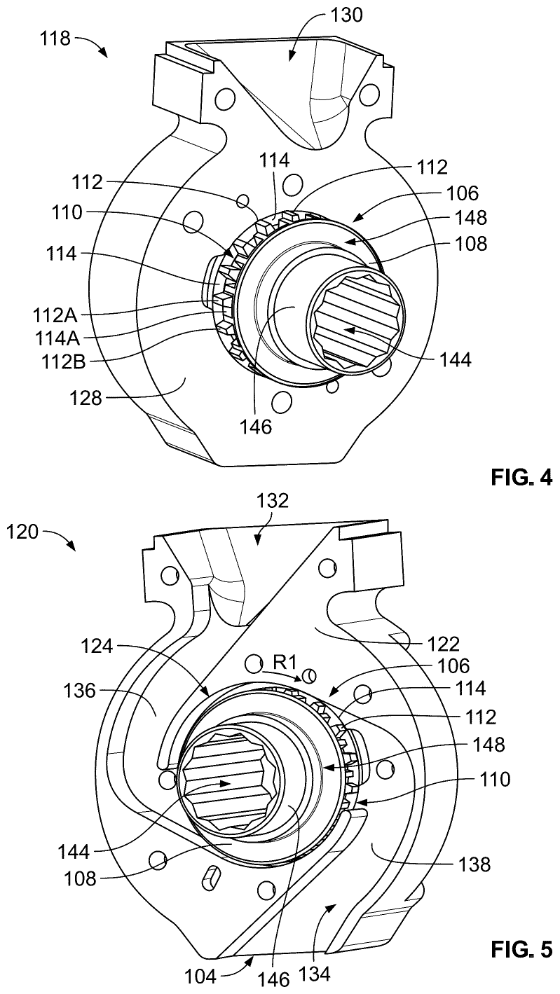

The treatment assembly 50 generally includes a treatment applicator 100 (e.g., a metering device, etc.). The illustrated treatment applicator 100 generally includes an inlet 102, an outlet 104, and a rotatable wheel 106 (FIGS. 4-6) coupled between the inlet 102 and the outlet 104. The inlet 102 is configured to receive a treatment product from, for example, a hopper, a container, etc., and the outlet 104 is configured to dispense the treatment product to the ground (e.g., to soil (e.g., directly, etc.), into a furrow in the ground/soil created by a planter while planting seeds, etc.). In connection therewith, the treatment applicator 100 is configured to deliver, deposit, etc. (e.g., as a metering device, etc.) generally precise amounts of the treatment product to the ground (e.g., into the furrow, to a surface of the ground (e.g., to soil, etc.), etc.).

As used herein, the treatment product may be any suitable treating product, formulation, etc. such as, for example, an insecticide, an inoculum, a microbial, etc. In some embodiments, the treatment product may be in a dry state, such as in the form of, for example, a powder, granules, etc. In other embodiments, the treatment product may be in a wet or semi-wet state, such as in the form of, for example, a liquid, a slurry, etc. Further, the treatment product may be configured for use with seeds, for example, as a seed treatment product, or it may be configured for use with soil, for example, as a soil treatment product independent of any use with seeds.

With reference to FIGS. 4-6, the rotatable wheel 106 generally includes a circular-shaped base 108 and multiple tabs 112 (or vanes or paddles, etc.) extending from the base 108. For example, in the illustrated embodiment, the base 108 of the rotatable wheel 106 includes an outer circumferential surface 110, and the tabs 112 extend away from the outer circumferential surface 110 of the base 108. More specifically, the tabs 112 extend radially away from the base 108. In other words, each tab 112 extends in a generally normal direction from the outer circumferential surface 110.

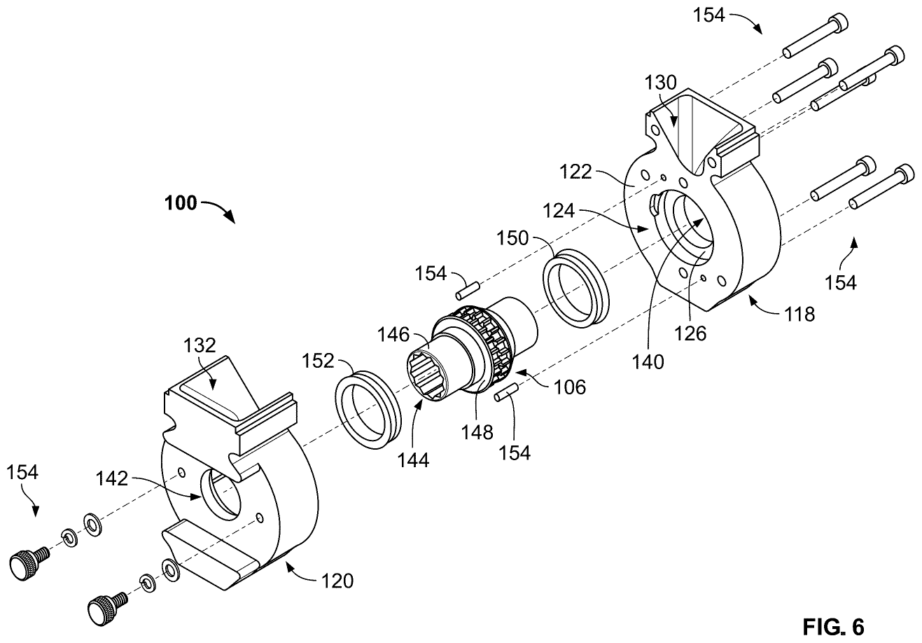

The tabs 112 are spaced apart circumferentially from each other along the outer circumferential surface 110 of the base 108 (e.g., generally evenly, etc.), with adjacent ones of the tabs then generally staggered (as shown in FIG. 6). In the illustrated embodiment, the treatment applicator 100 includes thirty-four total tabs 112 generally evenly spaced apart along the circumferential surface 110 (with seventeen tabs 112 generally located on one half of the wheel 106 and seventeen tabs 112 located on the other half of the wheel 106 (and generally staggered from the tabs 112 located on the one half of the wheel 106)). However, it should be appreciated that other numbers and/or arrangements of the tabs 112 may be utilized in other embodiments. That said, the tabs 112 may provide control with regard to the rate and/or amount (or volume) of treatment product dispensed from the assembly 50 (along with a diameter of the wheel 106, etc.). For instance, the flow rate of treatment product may be modified by increasing or decreasing the number of the tabs 112, by increasing or decreasing a diameter of the wheel 106, etc. In one particular example, a volume of treatment product dispensed from the assembly 50 may be reduced by increasing a diameter of the wheel 106, inserting a blank wheel (e.g., a wheel without tabs 112, etc.), etc. (e.g., whereby such change may be independent of (or may be in combination with) a speed (or a change in speed) of the agricultural device to which the assembly 50 is coupled, is independent of (or may be in combination with) a motor speed (or a change in motor speed) driving the wheel 106, is independent of (or may be in combination with) a number of tabs 112 on the wheel 106 (or a change in number of tabs 112 on the wheel 106), etc.).

The tabs 112 generally define receptacles 114 therebetween configured to receive the treatment product passing into the treatment applicator 100 through the inlet 102. Specifically, each adjacent set of tabs 112 defines a receptacle 114 therebetween (e.g., together with sidewalls of the base 108, etc.). For example, and as best shown in FIG. 4, adjacent tabs 112A, 112B (of the collection of tabs 112) define a receptable 114A (of the collection of receptacles 114).

The receptacles 114 are generally sized, shaped, etc. to receive the treatment product therein (e.g., an insecticide, etc.). For example, the size and shape of the receptacles 114 are generally based on the location of and the number of tabs 112 along the base 108. Further, the size of the receptacles 114 at least partially defines the amount of the treatment product received therein. For example, a larger sized receptacle 114 can receive more treatment product than a smaller sized receptacle 114. As such, the size and shape of the receptacles 114 may be adjusted by moving the tabs 112, removing some of the tabs 112, adding additional tabs, etc., thereby adjusting the amount of the treatment product received in the receptacles 114. To this point, the wheel 106, and the receptacles 114 defined by the tabs 112 of the wheel 106, provide for deliver of generally accurate and consistent amounts of treatment product within the furrow (at particular/desired locations) (as compared to previous applicators that pumped treatment products into furrows leaving generally random dotted lines of product along the furrow). What's more, it should be appreciated that rotation of the wheel 106 may be adjusted on the fly (e.g., while treatment product is being delivered, etc.) to thereby generally automatically increase or decrease an amount of the treatment product being delivered, as desired.

Although the wheel 106 is illustrated and described as including a specific number of tabs 112 arranged in a particular manner, it should be appreciated, again, that the wheel 106 may include more or fewer tabs 112 and/or tabs 112 arranged in a different manner (e.g., spaced apart in a different manner, extending at an acute or obtuse angle from the outer circumferential surface 110, etc.) and/or differently shaped tabs 112 than illustrated, if desired. For example, the wheel 106 (and/or any other wheel herein) may include any suitable number of tabs such as twenty tabs, thirty-four tabs, sixty tabs, more than sixty tabs, etc. What's more, the wheel 106 may have any desired diameter in conjunction with accommodating the tabs 112. For example, the wheel 106 may have a diameter of about 1.5 inches with thirty-four tabs thereon, the wheel may have a diameter of about two inches with sixty tabs therein, etc. In other examples, the tabs 112 may extend at an acute angle from the base 108.

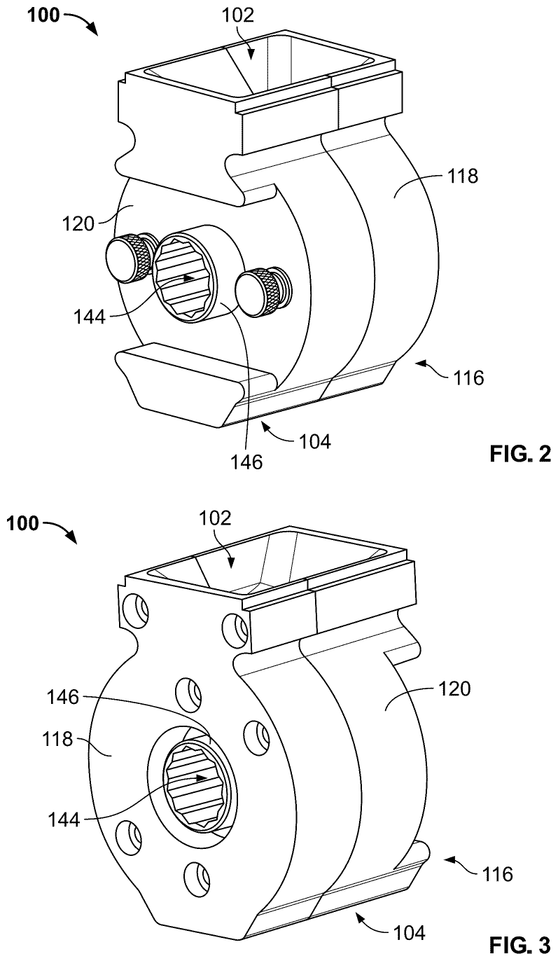

With additional reference to FIGS. 2 and 3, the treatment applicator 100 further includes a housing 116 configured to surround the rotatable wheel 106. For example, in the illustrated embodiment, the housing 116 is formed of two housing members 118, 120 connected together via multiple fastening devices (e.g., bolts, nuts, pegs, etc.) 154. The housing members 118, 120 may be formed of a suitable material such as metal (e.g., aluminum, steel, alloys thereof, etc.), plastic, etc. As shown in FIGS. 4 and 5, the housing member 120 includes an inner surface 122 defining a central opening 124 arranged to receive the rotatable wheel 106. For example, the central opening 124 of the housing member 120 has a generally circular-shape and depth (defined by an inner ridge 126 (FIG. 6)) to receive the circular-shaped base 108 and the tabs 112 of the wheel 106. The housing member 118 similarly has a generally flat inner surface 128 that faces and corresponds to the inner surface 122 of the housing member 120. As such, when the wheel 106 is positioned in the central opening 124 of the housing member 120 and against the inner ridge 126 and when the housing members 118, 120 are abutted against each other, the housing 116 generally surrounds the rotatable wheel 106.

The housing 116 generally defines the inlet 102 and the outlet 104. More specifically, and as shown in FIGS. 4-6, the inner surfaces 122, 128 of the housing members 118, 120 define upper openings 130, 132 near the top sides of the housing members 118, 120. The upper openings 130, 132 are generally mirrored and have the same shape and size. With this configuration, the upper openings 130, 132 of the housing members 118, 120 collectively form the inlet 102 when the housing members 118, 120 are abutted against each other. Additionally, and as shown in FIG. 5, the inner surface 122 of the housing member 120 defines a lower opening 134 near its bottom side. When the housing members 118, 120 are abutted against each other, the lower opening 134 of the housing member 120 along with the generally flat inner surface 128 of the housing member 118 form the outlet 104.

Additionally, the housing 116 defines multiple channels between the inlet 102, the outlet 104, and the wheel 106. Specifically, as shown in FIG. 5, in this example, the inner surface 122 of the housing member 120 defines a channel 136 extending between the upper opening 132 (broadly, the inlet 102) and the wheel 106, and a channel 138 extending between the wheel 106 and the lower opening 134 (broadly, the outlet 104). As shown, the channels 136, 138 have generally inverse shapes. For example, the channel 136 extends outwardly from the upper opening 132 towards an adjacent edge of the housing member 120 and then curves inwardly towards an opening adjacent to a side of the wheel 106. Similarly, the channel 138 extends outwardly from the lower opening 134 towards an opposing adjacent edge of the housing member 120 and then curves inwardly towards to an opening adjacent to an opposing side of the wheel 106. In other words, the channel 136 generally forms a curved “L” shape, and the channel 138 generally forms a curved “7” shape. With this configuration, the treatment product passing through the inlet 102 is guided downward (due to gravity) and along the curved portion of the channel 136 towards the wheel 106. Additionally, any treatment product leaving the wheel 106 is guided downward (due to gravity) and along the curved portion of the channel 138 towards the outlet 104. As such, the rate of descent of the treatment product from the inlet 102 and towards the outlet 104 may be at least partially controlled due to the curved portions of the channels 136, 138. What's more, this configuration generally takes advantage of the angle of repose for granular treatment products, for example, to inhibit (e.g., prevent, etc.) the leakage of such products from the treatment applicator 100 (e.g., from the housing, etc.) when the treatment applicator 100 is not operating, is idle, is not turned on, etc. (e.g., when the treatment applicator 100 is not intended to dispense the treatment products, etc.).

As shown in FIG. 6, the treatment applicator 100 includes bushings 150, 152 positioned between the rotatable wheel 106 and the housing members 118, 120. More specifically, the bushing 150 is positioned between the rotatable wheel 106 and the housing member 118, and the bushing 152 is positioned between the rotatable wheel 106 and the housing member 120. In the illustrated embodiment, the bushings 150, 152 provide a barrier along the receptacles 114 of the wheel 106 to substantially prevent the treatment product from escaping from the receptacles 114 as the wheel 106 rotates.

With reference to FIGS. 1-6, the treatment applicator 100 generally defines a channel 144 arranged (e.g., sized, shaped, etc.) to receive a shaft 278 of motor 260. More specifically, the applicator 100 includes a tube 146 defining the channel 144. As shown, the tube 146 includes protrusions extending radially inward towards the channel 144 and configured to engage the motor shaft 278. In connection therewith, the housing members 118, 120 define channels 140, 142 and the base 108 of the rotatable wheel 106 defines a channel 148. The tube 146 extends through the channel 148 of the wheel 106 and attaches to an inner surface of the wheel 106. The tube 146 then extends into the channel 140, 142 of the housing members 118, 120. With this configuration, the motor 260 may drive rotation of the motor shaft 278 at a desired speed, thereby causing rotation of the wheel 106.

During operation of the treatment applicator 100, the treatment product passes through the inlet 102 and into the channel 136. As the wheel 106 rotates (in the direction R1 in FIG. 5, for example) via the motor 260, individual ones of the receptacles 114 receive a portion (e.g., one or more granules, an amount of slurry or liquid, etc.) of the treatment product. The amount of the treatment product received in each receptacle 114 may depend on, for example, the size of the receptacle 114, the rotational speed of the wheel 106 (and/or the motor), the amount of the treatment product collected in the channel 136, etc. The wheel 106 then transports the portion of the treatment product in the individual ones of the receptacles 114 and delivers the portion of the treatment product to the channel 138. The portion of the treatment product then passes through the channel 138 and the outlet 104, where it is dispensed, for example, to a furrow adjacent a planted seed, to soil (e.g., independent of planting a seed, in conjunction with planting the seed, etc.). With this configuration, the rotational speed of the wheel 106 may be controlled (via the motor 260 and a controller) to achieve a desired flow rate of the treatment product (e.g., based on and/or to generally match a planting rate of seeds, etc.). For example, a change in the rotational speed of the wheel 106 may alter a period of time for transporting the treatment product to the outlet 104 (and subsequently delivering the treatment product into the furrow, etc.). As such, with the desired flow rate, the dispensed treatment product may be positioned in the furrow adjacent to one or more seeds (which were previously dispensed in the furrow by the planter) before the planter subsequently closes the furrow, or in desired amounts to soil independent of seed planting. In various embodiments, rotation of the wheel 106 may be calibrated before planting to set the desired flow rate of the treatment product as further explained herein.

With reference again to FIG. 1, the treatment assembly further includes an enclosure 256, an exit member 258, and the motor 260. The enclosure 256 is sized and shaped to generally surround the applicator 100 including its rotatable wheel 106. For example, the enclosure 256 generally includes a base (or a housing) 262 and a door 264 attached to the base 262 via multiple fastening devices (e.g., bolts, washers, etc.) 266. More specifically, the base 262 includes a generally planar side 268 and two legs 270, 272 extending from the side 268 towards the door 264. The legs 270, 272 include inner curved surfaces facing each other. The door 264 is attachable to the legs 270, 272 via the fastening devices 266.

In the illustrated embodiment, the enclosure 256 defines openings to allow treatment product to pass therethrough. More specifically, and as shown in FIG. 1, the side 268 and the legs 270, 272 of the base 262 define an upper opening 274 and a lower opening 276. The upper opening 274 generally aligns with and is adjacent to the inlet 102 of the applicator 100 and the lower opening 276 generally aligns with and is adjacent to the outlet 104 of the applicator 100.

As shown, the exit member 258 defines a generally funnel-like shape and is coupled to the enclosure 256. For example, the inner surfaces of the legs 270, 272 may define grooves for receiving edges of the exit member 258. In other embodiments, the exit member 258 may be coupled to the enclosure 256 in another suitable manner such as with one or more fastening devices, etc. When the exit member 258 is coupled to the enclosure 256, the exit member 258 is generally aligned with and adjacent to the lower opening 276 of the enclosure 256 (and therefore the outlet 104 of the applicator 100). With this configuration, the funnel-shaped exit member 258 generally receives the treatment product from the rotatable wheel 106 of the applicator 100 (as explained above) and allows the treatment product to pass therethrough in a controlled manner.

As described above, the motor 260 includes the rotatable shaft 278, which extends through the channel 144 of the applicator 100. As such, the motor 260 may rotate the wheel 106 of the applicator 100 by rotating the shaft 278. The motor 260 may be a stepper motor for driving rotation of the wheel 106 or another suitable motor (e.g., a servo motor, etc.).

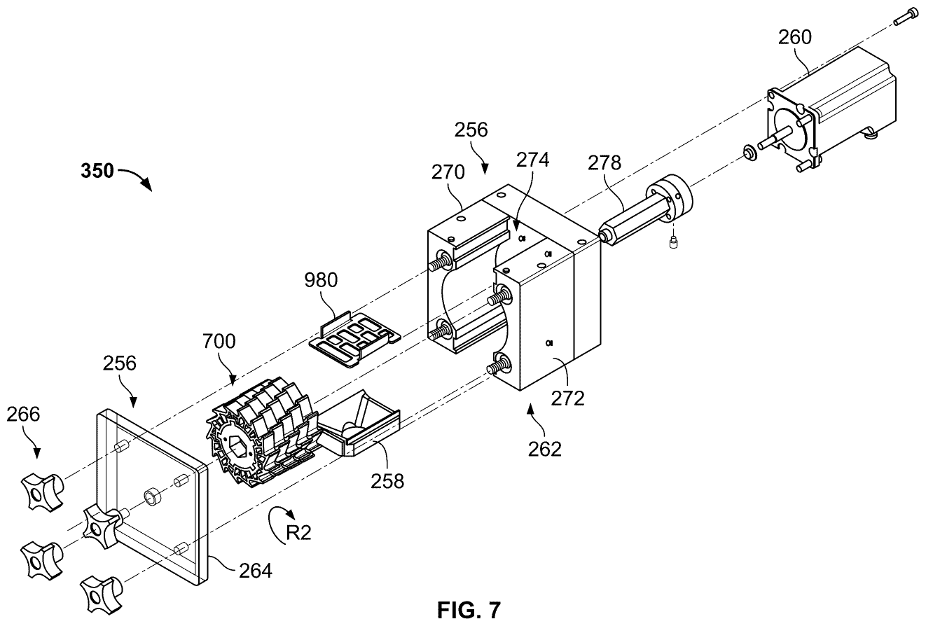

FIGS. 7-9 illustrate another example embodiment of a treatment assembly 350 including one or more aspects of the present disclosure. The assembly 350 is substantially similar to the assembly 50 of FIGS. 1-6. As such, corresponding parts are generally identified with corresponding reference numbers. For example, the assembly 350 generally includes the enclosure 256 (with the base 262 and the door 264), the exit member 258, the motor 260, and the motor shaft 278 as described above with reference to the treatment assembly 50. In addition, the treatment assembly 350 of this embodiment may also be included in a treatment system (e.g., treatment system 1000, treatment system 1100, etc.) connected to a planter (e.g., planter 1200, etc.) or other agricultural machine for use in applying a treatment product to seeds as the seeds are planted by the planter, to the ground (e.g., to soil, etc.) as desired (e.g., to treat the soil independent of planting seeds, etc.).

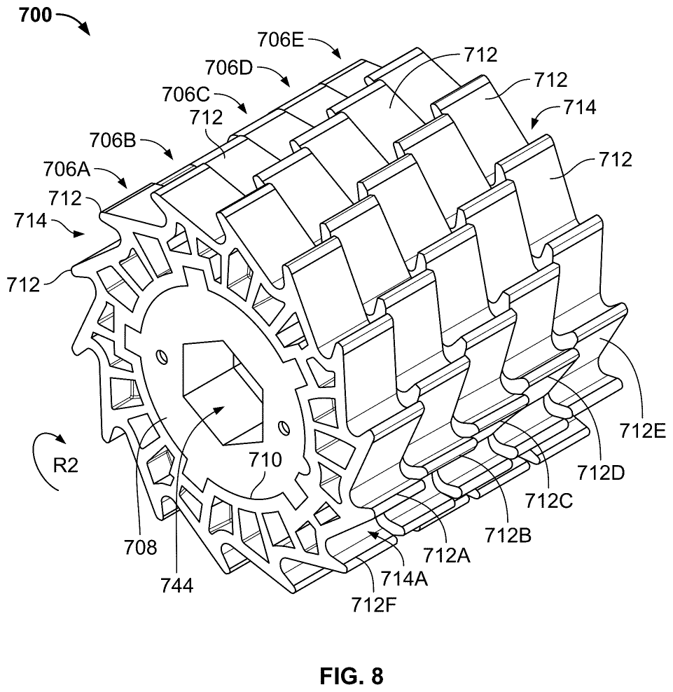

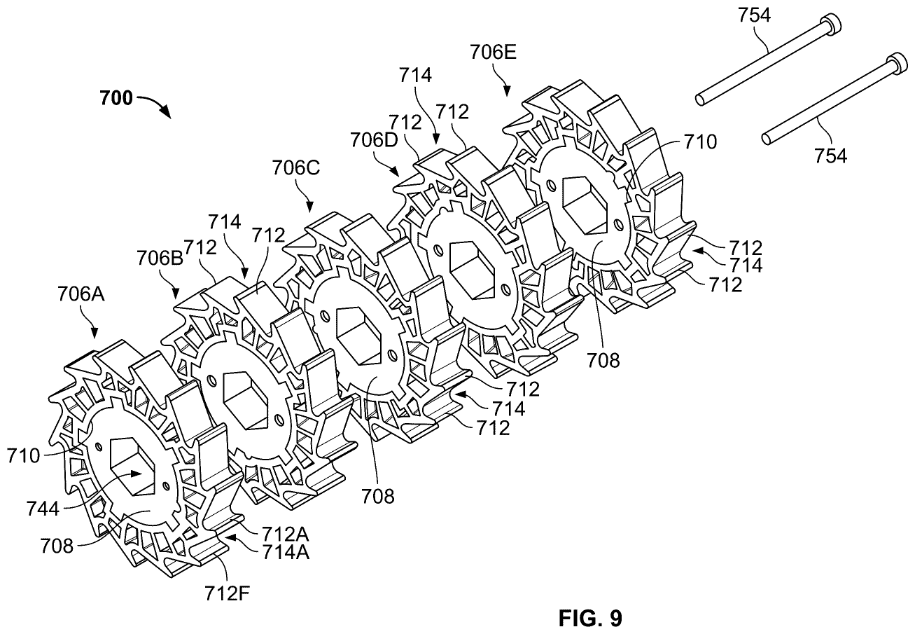

In this embodiment, the assembly 350 includes a different treatment applicator 700 (e.g., metering device, etc.) than the assembly 50. In particular in this embodiment, the applicator 700 of the assembly 350 is formed generally as a wheel assembly (e.g., as a metering wheel, etc.). As best shown in FIGS. 8 and 9, the applicator 700 generally includes five rotatable wheels 706A-E (collectively, wheels 706) coupled together with multiple fastening devices (e.g., bolts, pegs, etc.) 754. With that said, it should be appreciated that the applicator 700 may include more or fewer rotatable wheels. For instance, the wheel assembly may include two, three, four, six, seven, or more than seven rotatable wheels if desired (e.g., at least five rotatable wheels, etc.).

Similar to the wheel 106 of the applicator 100, each rotatable wheel 706 of the applicator 700 generally includes a circular-shaped base 708 having an outer circumferential surface 710, and tabs 712 extending away from the outer circumferential surface 710 of the base 708. More specifically, the tabs 712 of each wheel 706 extend at an acute angle away from the outer circumferential surface 710 of the base 708. For example, each tab 712 may extend in a tangential direction from its corresponding outer circumferential surface 710. In addition, the tabs 712 are spaced apart circumferentially from each other along the corresponding outer circumferential surface 710 of their respective base 708. More specifically, in the illustrated embodiment, each wheel 706 includes fourteen tabs 712 generally evenly spaced apart. However, wheels in other embodiments may include more than fourteen tabs or fewer than fourteen tabs in other example embodiments. In connection therewith, diameter of the wheel 706 and/or the number of tabs 712 on the wheel 706 may be changed to reduce or increase the amount (e.g., flow rate, etc.) of treatment product that is being dispensed. What's more, different numbers of tabs 712 may be used in connection with dispensing different types of treatment product (e.g., based on a size of particles in the product, etc.).

Additionally, and similar to the tabs 112 of the applicator 100, the tabs 712 in this embodiment generally define receptacles 714 (or pockets, etc.) configured to receive the treatment product therein. Specifically, each adjacent set of tabs 712 (of a given wheel 706) defines a receptacle 714 therebetween. For example, and as shown in FIGS. 8 and 9, adjacent tabs 712A, 712F of the wheel 706A define a receptable 714A. The receptacles 714 are generally sized, shaped, etc. to receive the treatment product therein (e.g., a pellet or particle of an inoculum, etc.). For example, the size and shape of the receptacles 714 are generally based on the location of and the number of tabs 712. And, the size of the receptacles 714 at least partially defines the amount of the treatment product received therein. As such, the size and shape of the receptacles 714 may be adjusted by moving and/or removing tabs 712, adding additional tabs, etc., thereby adjusting the amount of the treatment product received in the receptacles 714.

With continued reference to FIGS. 8 and 9, the tabs 712 of adjacent wheels of the rotatable wheels are staggered (or offset or rotated, etc.) (e.g., about 0.5 degrees, about one degree, about two degrees, about three degrees, about four degrees, about five degrees, about ten degrees, less than about 0.5 degrees, more than about ten degrees, etc.) relative to each other. For example, as shown best in FIG. 8, the tabs 712A-E of the wheels 706A-E, respectively, are staggered. More specifically, the tab 712A of the wheel 706A is slightly offset from the tab 712B of the wheel 706B, the tab 712B is then slightly offset from the tab 712C of the wheel 706C, and so on. This offset configuration of tabs 712A-E of adjacent wheels 706A-E creates a sloping flow path between the receptacles 714. In turn, this allows the treatment product to flow in a controlled and consistent manner down the sloping flow path as the wheels 706A-E rotate (as a collective unit). The particular arrangement (e.g., offset, etc.) of the adjacent wheels may be determined based on a type of the treatment product being dispensed, a desired flow rate of product, etc.

Further, the tabs 712 of the applicator 700 of this embodiment are generally flexible, resiliently deformable, etc. For example, the tabs 712 and their supporting structure may be molded from a suitable flexible material such as rubber, plastic, etc. As such, the tabs 712 may flex (e.g., outwardly, laterally, etc.) when the treatment product passes through the sloping flow path between the receptacles 714. As a result, the treatment product may be substantially inhibited from becoming stuck or trapped in any one of the receptacles 714, whereby blockage (or jamming) of the applicator 700 with (or by) treatment product may be inhibited.

Although the wheels 706 are illustrated and described as including a specific number of tabs 712 arranged in a particular manner, it should be appreciated that the wheels 706 may include more or fewer tabs 712 and/or tabs 712 arranged in a different manner (e.g., spaced apart in a different manner, extending radially from the outer circumferential surface 710, etc.), if desired. For example, each wheel 706 may include any suitable number of tabs such as ten tabs, fifteen tabs, twenty tabs, twenty-five tabs, thirty tabs, more than thirty tabs, fewer than ten tabs, etc., for example, depending on a desired flow rate of treatment product, etc. In the illustrated embodiment, again, the wheels 706 each include fourteen tabs 712.

With additional reference to FIG. 7, the wheels 706A-E collectively define a channel arranged (e.g., sized, shaped, etc.) to receive shaft 278 of motor 260. For example, the base 708 of each wheel 706A-E defines an inner channel 744 extending therethrough. The inner channels 744 of the wheels 706A-E are aligned with each other and have a hexagonal shape configured to engage (e.g., mate with, match in shape with, etc.) the motor shaft 278. As such, when the wheels 706A-E are coupled together with the fastening devices 754, the motor 260 may drive rotation of the motor shaft 278 at a desired speed, thereby causing rotation of the collection of wheels 706A-E (as a unit). With that said, it should be appreciated that the wheels 706A-E may define a differently shaped channel (e.g., a triangular shaped channel, a square shaped channel, a pentagonal shape channel, etc. and configured to match a shape of the shaft 278; etc.) while achieving the same result (e.g., rotation of the wheels 706A-E, etc.).

The assembly 350 further includes an inlet configured to receive a treatment product from, for example, a hopper, a container, etc. In connection therewith, the assembly 350 includes a guard member 980 (broadly, an inlet and/or disposed at an inlet of the assembly 350) coupled to the enclosure 256. For example, the inner surfaces of the legs 270, 272 may define grooves for receiving edges of the guard member 980. In other embodiments, the guard member 980 may be coupled to the enclosure 256 in another suitable manner such as with one or more fastening devices. When the guard member 980 is coupled to the enclosure 256, the guard member 980 is generally aligned with and adjacent to the upper opening 274 of the enclosure 256 and the receptacles 714 of the applicator 700 as the wheels 706 rotate. In the illustrated embodiment, the guard member 980 generally includes a plate defining multiple openings. The openings are sized and shaped to allow treatment products to pass therethrough and to substantially prevent debris (e.g., leaves, sticks, paper, etc.) from entering the assembly 350 and/or reaching the applicator 700.

During operation, the treatment product passes through the openings of the guard member 980. As the wheels 706 of the applicator 700 rotate (in the direction R2 in FIGS. 7 and 8), individual ones of the sloping flow paths (created from the receptacles 714 of adjacent staggered tabs 712) receive a portion (e.g., one or more granules, etc.) of the treatment product. The amount of the treatment product received in each sloping flow path may depend on, for example, the size of the receptacles 714, the rotational speed of the wheels 706 of the applicator 700 (and/or the motor 260), etc. The applicator 700 then transports the portion of the treatment product in the individual ones of the sloping flow paths and delivers the portion of the treatment product to the funnel-shaped exit member 258, where it is dispensed, for example, to a furrow or otherwise. With this configuration, the rotational speed of the applicator 700 may be controlled (via the motor 260 and a controller) to achieve a desired flow rate of the treatment product, thereby allowing the dispensed treatment product to be positioned, for example, in the furrow adjacent to one or more seeds (which were previously dispensed in the furrow by the planter) before the planter subsequently closes the furrow, to the soil on the ground at desired locations and/or in desired amounts (e.g., independent of planting seeds in the soil, in conjunction with planting seeds in the soil, etc.). In various embodiments, rotation of the applicator 700 may be calibrated before planting (or, more generally, before operation of the assembly 350, etc.) to set the desired flow rate of the treatment product as further explained herein.

In some embodiments, the assembly 350 may include different components. For example, the applicator 700 may be replaced with the applicator 100 or another suitable treatment dispensing device, the guard member 980 may be removed, etc. In such examples, a user can easily replace, remove, add, etc. components by removing the door 264 from the base 262 (e.g., by manipulating the fastening devices 266, etc.), sliding, guiding, pulling, etc. a component (e.g., the guard member 980, the applicator 700, etc.) away from the base 262, and then optionally sliding, guiding, inserting, etc. a new component (e.g., the applicator 100, etc.) onto the base 262, the motor shaft 278, etc. This interchangeability of components is also possible with the assembly 50 of FIGS. 1-6.

In various embodiments, rotation of the wheels herein may be calibrated before planting to set a desired flow rate of the treatment product. For example, the number of revolutions of the motor 260 or any other motor herein may be set to any suitable value such as five, ten, fifteen, etc. revolutions per time interval. In some examples, a user may set this value through a user interface associated with a controller for controlling the motor 260. Then, the motor 260 is controlled to move the set number of revolutions. For example, the user may select an input on the user interface to move the motor 260. When the motor 260 moves the set number of revolutions, an amount of the treatment product is dispensed from the rotating wheel (e.g., the wheel 106 of the assembly 50, the wheels 706 of the assembly 350, etc.). For example, when the motor 260 moves ten revolutions, a particular volume (e.g., 0.5 cubic centimeter, 1 cubic centimeter, 1.5 cubic centimeters, 2 cubic centimeters, etc.) of the treatment product is output from the corresponding rotating wheel. This amount of the treatment product may be determined by measuring, calculating, etc. the volume of the treatment product output from the rotating wheel. In some examples, a user may place a container such as a graduated cylinder below an outlet (e.g., the outlet 104, the exit member 258, an exit tube, etc.) to measure the treatment product. Once the amount of the treatment product is known for a given number of revolutions of the motor 260, that amount (or a derivation thereof such as an amount per one revolution) may be used as a parameter for controlling the speed of the motor 206 to achieve a desired flow rate of the treatment product, thereby allowing a desired amount of the dispensed treatment product to be positioned, for example, in a furrow adjacent to one or more seeds, at desired locations in/on the soil, etc. In some examples, this calibration process may be completed for each row in a plot to achieve improved consistency and accuracy. In other examples, the calibration process may be completed for each plot, each field, etc.

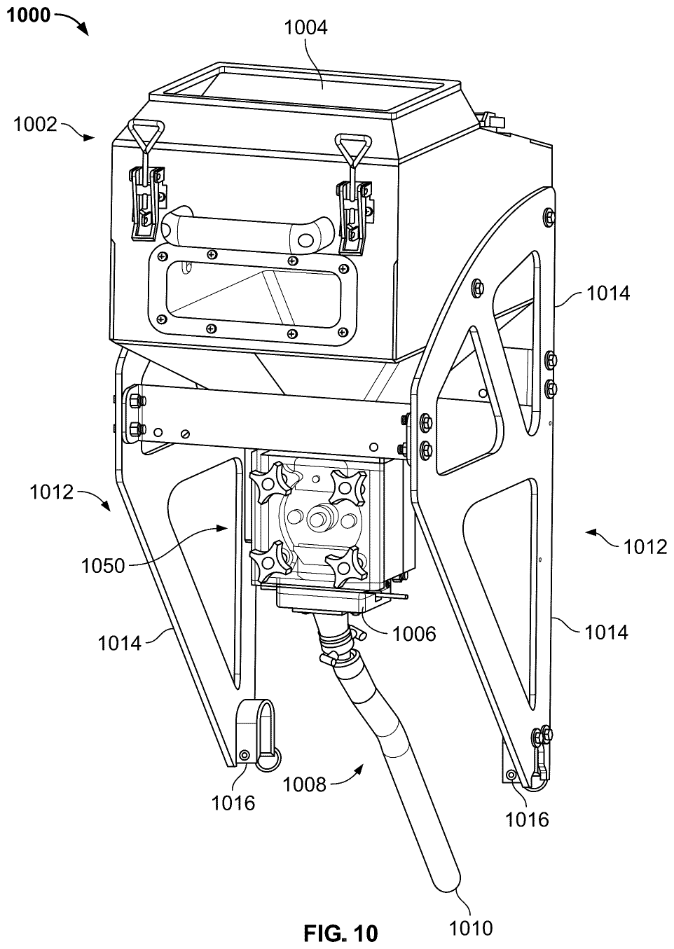

FIG. 10 illustrates an example embodiment of a treatment system 1000 including one or more aspects of the present disclosure. As further explained herein, the treatment system 1000 may be connected to a planter or other agricultural machine for use in planting seeds and applying a seed treatment product while the seeds are being planted, to soil as the planter or other agricultural machine traverses a field (e.g., independent of planting seeds in the soil or in connection with planting seeds in the soil, etc.). As shown, the system 1000 generally includes a hopper 1002, a treatment assembly 1050 connected to the hopper 1002, a sensor 1006, and an exit tube 1008. The treatment assembly 1050 may include either the assembly 50 or the assembly 350, which operates as explained above, whereby either the assembly 50 or the assembly 350 may be used in the system 1000 (and whereby corresponding parts in the following description are identified with corresponding reference numbers). In connection therewith, for example, a motor (e.g., motor 260, etc.) of the assembly 1050 may be activated according to a signal from a controller, thereby causing rotation of a wheel(s) of the assembly 1050 (e.g., the wheel 106, the wheels 706, etc.).

The hopper 1002 generally includes an inlet 1004, an interior chamber defined by walls of the hopper 1002, and an outlet. The hopper 1002 is configured to receive and store a treatment product, and provide the treatment product to the treatment assembly 1050. For example, the interior chamber may be sized, shaped, etc. to receive and store the treatment product. And, the treatment product may be delivered to the interior chamber via the inlet 1004 of the hopper 1002. In some examples, the treatment product may be automatically delivered to the hopper 1002 from a storage container or unit positioned above the hopper 1002. Then, the hopper 1002 feeds the treatment product to the treatment assembly 1050 via its outlet. In such examples, the outlet of the hopper 1002 is adjacent to an inlet (e.g., upper opening 274, etc.) of the treatment assembly 1050.

The sensor 1006 is connected below the treatment assembly 1050. With this arrangement, the sensor 1006 is positioned adjacent to an outlet (e.g., lower opening 276, etc.) of the assembly 1050 so that the treatment product exiting the assembly 1050 passes through, by, etc. the sensor 1006, thereby allowing the sensor 1006 to detect movement of the treatment product passing through the outlet of the assembly 1050. In connection therewith, the sensor 1006 may provide feedback to a controller relating to whether the treatment product is flowing (or moving) or not flowing (which may be indicative of a blockage in the system 1000). In various embodiments, the sensor 1006 may be a flow sensor or another suitable sensor to detect movement (e.g., mechanical sensors, microwave sensors, etc.).

The exit tube 1008 is generally coupled to the outlet of the treatment assembly 1050 via or at or adjacent, for example, the sensor 1006. The exit tube 1008 includes an elongated hollow hose or tube (or channel) having an inlet adjacent to the outlet of the treatment assembly 1050 and an opposing outlet 1010. In such examples, the exit tube 1008 may extend to, into, etc. a furrow created by a planter while planting seeds, or may extend adjacent a surface of the ground. In this manner, the treatment product exiting the assembly 1050 enters the inlet of the exit tube 1008, passes through the exit tube 1008 (due to gravity), and then is dispensed (via the outlet 1010 of the exit tube 1008), for example, into the furrow adjacent to one or more planted seeds, to a surface of the soil/ground, etc.

With continued reference to FIG. 10, the treatment system 1000 also includes a mounting frame 1012 having various mounting members 1014 and attachment members 1016. As shown, the hopper 1002 is connected to the mounting frame 1012 via a portion of the mounting members 1014. In this manner, the mounting frame 1012 supports the hopper 1002, along with the assembly 1050, the sensor 1006, and the exit tube 1008 generally coupled to the hopper 1002. The attachment members 1016 may include pins, clips, etc. for attaching the treatment system 1000 to a planting unit of the planter.

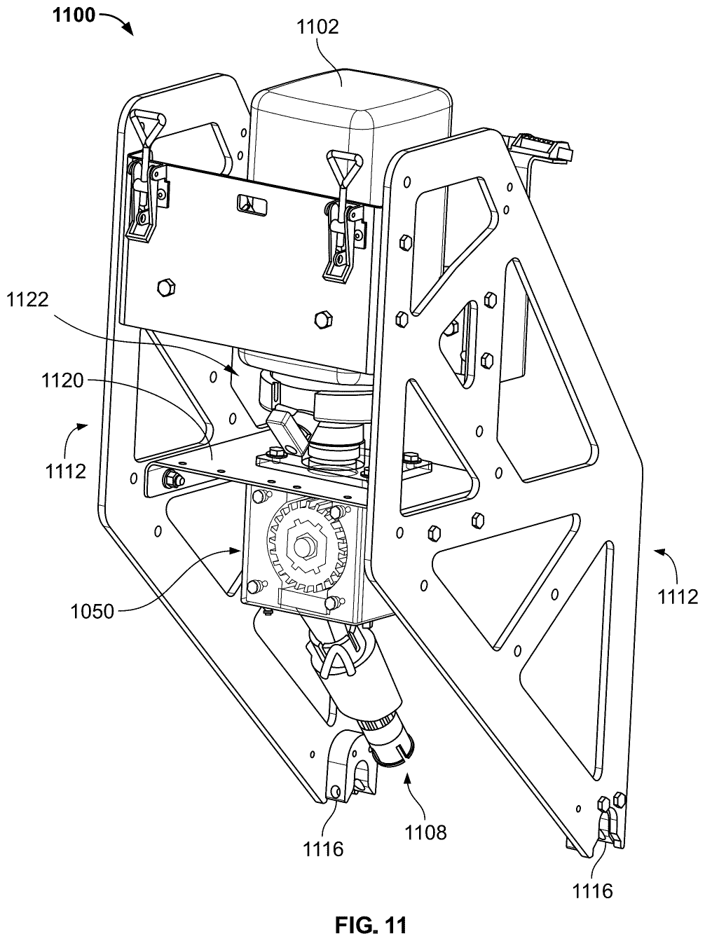

FIG. 11 illustrates another example embodiment of a treatment system 1100 including one or more aspects of the present disclosure. The treatment system 1100 may be connected to a planter or other agricultural machine for use in planting seeds and applying a treatment product, or for use in applying the treatment product (e.g., to soil, etc.) independent of planting seeds. The treatment system 1100 is substantially similar to the treatment system 1000 of FIG. 10, but in this embodiment includes a detachable container 1102 instead of hopper 1002.

For example, the treatment system 1100 generally includes the container (or bottle) 1102, treatment assembly 1050 connected to the container 1102 via plate 1120, a sensor (not visible), and an exit tube 1108. The sensor and the exit tube 1108 function in a similar manner as the sensor 1006 and the exit tube 1008 of FIG. 10. While the exit tube 1108 is shown as extending a short distance from the treatment assembly 1050, it should be appreciated that the exit tube 1108 may extend further (e.g., a distance sufficient to reach a furrow, etc.) and/or another tube may be connected to the exit tube 1108. In addition, it should again be appreciated that the treatment assembly 1050 may include either the assembly 50 or the assembly 350, which operates as explained above, whereby either the assembly 50 or the assembly 350 may be used in the system 1100.

In the illustrated embodiment, the container 1102 is a device for storing a pre-filled amount of treatment product such as microbials, insecticides, inoculums, etc. The container 1102 generally includes an opening and an interior chamber defined by walls of the container 1102 for storing the treatment product.

The container 1102 is detachably coupled to the plate 1120 with the opening of the container 1102 facing the plate 1120. For example, the container 1102 may be snapped into place on one side of the plate 1120 via one or more fastening devices (e.g., clamps, clips, etc.). In other embodiments, the container 1102 may be attached to the plate 1120 in another suitable manner such as with, for example, bolts, screws, and/or other fastening devices. When desired, the container 1102 may be detached from the plate 1120 by manipulating (e.g., releasing, pressing, unscrewing, etc.) the fastening devices. As such, the container 1102 with one type of treatment product may be detached, and then another container with different type of treatment product may be attached for use. In addition in this embodiment, the container 1102 includes a valve assembly 1122 adjacent an outlet thereof (e.g., adjacent where the container 1102 couples to the plate 1120, etc.) to control flow of treatment product from the container 1102 and to allow for closing the container 1102, for example, when removing the container 1102 from the plate 1120 (e.g., to inhibit leakage of treatment product, etc.).

The assembly 1050 is connected to an opposing side of the plate 1120. As such, when the container 1102 is coupled to the plate 1120, the opening of the container 1102 (and valve assembly 1122) is adjacent to an inlet (e.g., upper opening 274, etc.) of the assembly 1050. In this manner, the treatment product in the container 1102 may be passed (via the opening of the container 1102) to the assembly 1050.

With continued reference to FIG. 11, the treatment system 1100 also includes a mounting frame 1112 having various mounting members and attachment members 1116. The mounting frame 1112, the mounting members and the attachment members 1116 function in a similar manner as the mounting frame 1012, the mounting members 1014 and the attachment members 1016 of the system 1000.

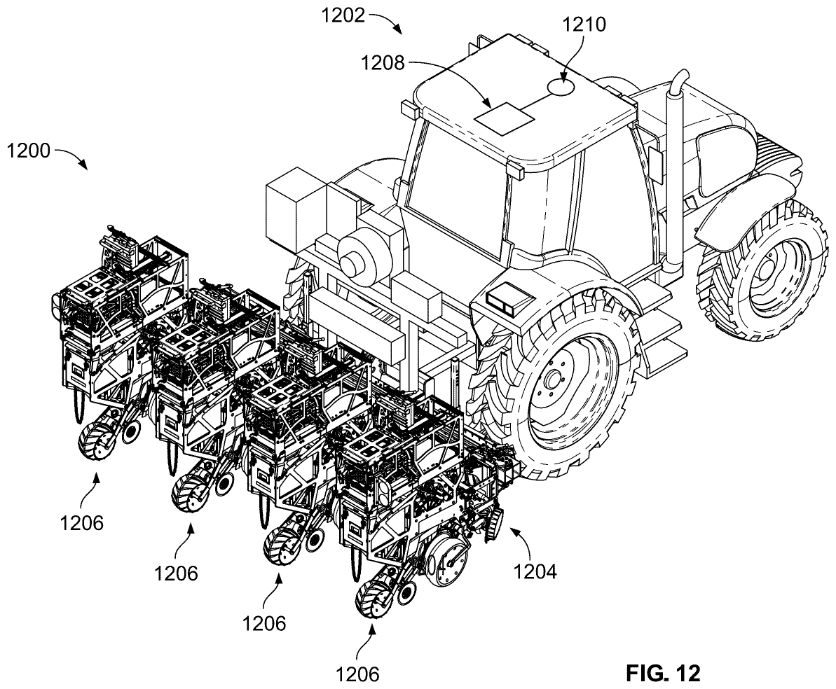

FIGS. 12-14 illustrate an example embodiment of a multi-row planter 1200 including one or more aspects of the present disclosure. As further explained herein, the planter 1200 is configured to plant seeds in a field or plot. In particular, in this example embodiment, when the planter 1200 is in the field, it may be adapted to be towed by a conventional tractor 1202 for planting the seeds. And, a control system 1208 is provided in communication with the planter 1200, and is configured to control one or more operations of the planter 1200 and/or of the tractor 1202. For example, the control system 1208 may be configured to control rotation of the wheel 106 of the applicator 100, the wheels 706 of the applicator 700, etc. via the motor 260.

As illustrated, the control system 1208 is disposed in the tractor 1202. However, the control system 1208 may be located otherwise, for example, on the planter 1200 or remote therefrom in other embodiments. In connection therewith, the control system 1208 may include (and/or be associated with) a global positioning system (GPS) receiver 1210, whereby the control system 1208 and the GPS receiver 1210 may be configured to control operation of the tractor 1202 to move through the field/plot, and to control operation of the planter 1200 to plant seeds in the field/plot (as generally described herein). In addition, in some embodiments, the planter 1200 may be fully automated and may make use of planting plans to determine seeds to be planted (in conjunction with the control system 1208 and the GPS receiver 1210), determine when to activate the motor of the treatment assembly 50 or the treatment assembly 350 (when included in the planter 1200), etc., and/or may make use of one or more sensors (and/or artificial intelligence from sources remote to the planter 1200 but still in communication with the planter 1200 via the control system 1208, etc.) to identify particular field characteristics and thus particular seeds to be planted (based on the field characteristics) as modifications to the planting plans (or as a basis of the planting plans) and/or particular locations to dispense treatment product to soil in the field.

The planter 1200 generally includes a frame 1204 supporting multiple planting units 1206, which are adjustable relative to the frame 1204. For example, the planting units 1206 are configured to slide laterally along the frame 1204 to thereby change spacing between the planting units 1206 (e.g., to allow for compact travel, to adjust spacing between the planting units 1206 during planting (e.g., on the fly without stopping, etc.) to thereby adjust spacing between rows of planted seeds, etc.). The planting units 1206 may also be configured to be collapsed or folded relative to the frame 1204 to a width such that the planter 1200 can travel on conventional roads. With that said, in this embodiment, the planter 1200 includes four planting units 1206. However, in other embodiments, the planter 1200 may include more than or fewer than four planting units within the scope of the present disclosure (e.g., two planting units, six planting units, eight planting units, twenty planting units, etc.). And, each of the planting units 1206 is substantially identical in structure and functionality. As such, for clarity and simplicity, a single one of the planting units 1206 is described hereinafter with it understood that such description equally applies to each of the other planting units 1206 of the planter 1200.

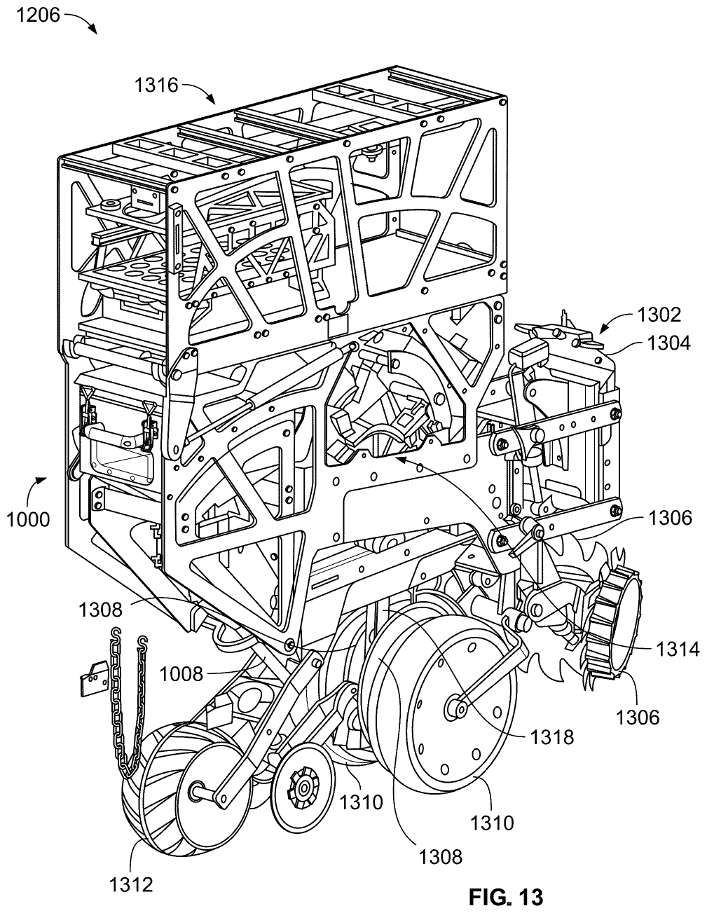

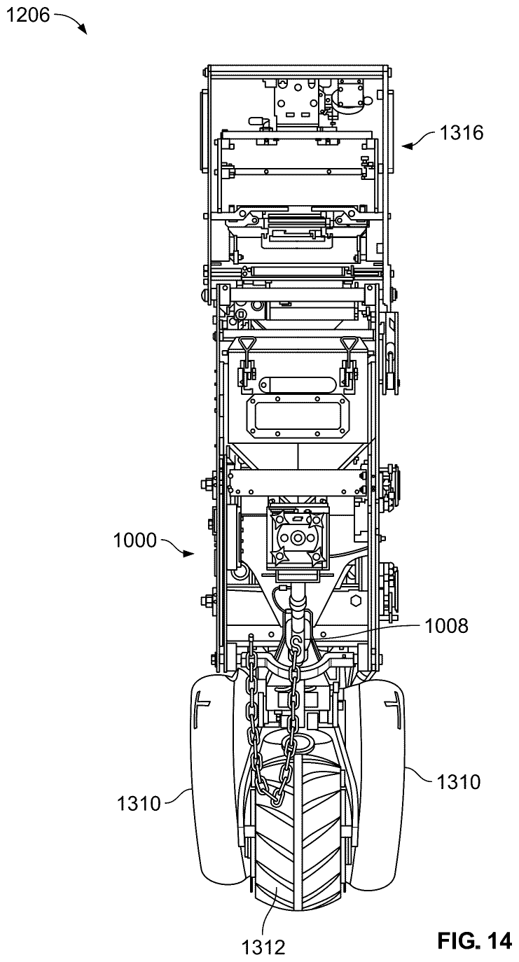

As shown in FIGS. 13 and 14, the planting unit 1206 includes a parallel linkage assembly 1302, having an actuator 1304 configured (e.g., structured, operable, etc.) to apply lifting and/or downward force on the planting unit 1206 relative to the frame 1204 (e.g., during planting, etc.). The planting unit 1206 also includes a pair of row cleaners 1306 configured to clear a path for planting, and a pair of furrow opening discs 1308 configured (in conjunction with the downward force applied by the parallel linkage assembly 1302) to open a V-shaped trench, or furrow, in the soil in the given field (into which seeds and/or seed treatment products are then dispensed by the planting unit 1206). The planting unit 1206 additionally includes a pair of gauge wheels 1310 configured to control a depth of the furrow formed by the opening discs 1308. In particular, a height of the gauge wheels 1310 relative to the opening discs 1308 controls the depth of the furrow. Further, the planting unit 1206 includes a closing wheel 1312 configured to close the furrow, after the seeds are deposited therein, and to cover the planted seeds.

The planting unit 1206 also includes a seed meter 1314 in communication with one or more seed storage units onboard the planting unit 1206 (e.g., a seed storage unit 1316). In this embodiment, the seed meter 1314 is disposed generally below the one or more seed storage units. As such, based on this positioning, gravity may be used to facilitate movement of the seeds from one or more storage units to the seed meter 1314 (however, air, etc. may also be used as desired in other embodiments). The seed meter 1314 is configured to receive seeds and dispense the received seeds into the furrow created by the planting unit 1206 (i.e., created by the furrow opening discs 1308) (via a planting tube 1318 in communication with the seed meter 1314). In particular, the seed meter 1314 is configured to receive seeds from the one or more storage units, meter the seeds, and then deposit (i.e., plant) a particular number (and/or volume) of the seeds into the furrow via the planting tube 1318 (see, e.g., Applicant's co-owned U.S. Pat. No. 10,159,176, the entire disclosures of which are incorporated herein by reference).

With continued reference to FIGS. 13-14, in this example, the planting unit 1206 further includes the treatment system 1000 of FIG. 10 generally positioned above the closing wheel 1312 and generally rearward of the seed meter 1314. As shown, the exit tube 1008 of the treatment system 1000 extends generally towards the opening discs 1308 with the outlet 1010 thereof positioned generally adjacent an outlet of the planting tube 1318. As such, the dispensed treatment product may be positioned in the furrow adjacent to (e.g., within about six inches or less, within about five inches or less, within about four inches or less, within about three inches or less, within about two inches or less, within about one inch or less, within about 0.5 inches or less, within about 0.25 inches or less, etc.) one or more seeds (which were previously dispensed in the furrow by the seed meter 1314 and the planting tube 1318) before the closing wheel 1312 subsequently closes the furrow. In addition, in various examples, the planting unit 1206 may operate, via the treatment system 1000, to dispense treatment product to the ground independent of planting any seeds.

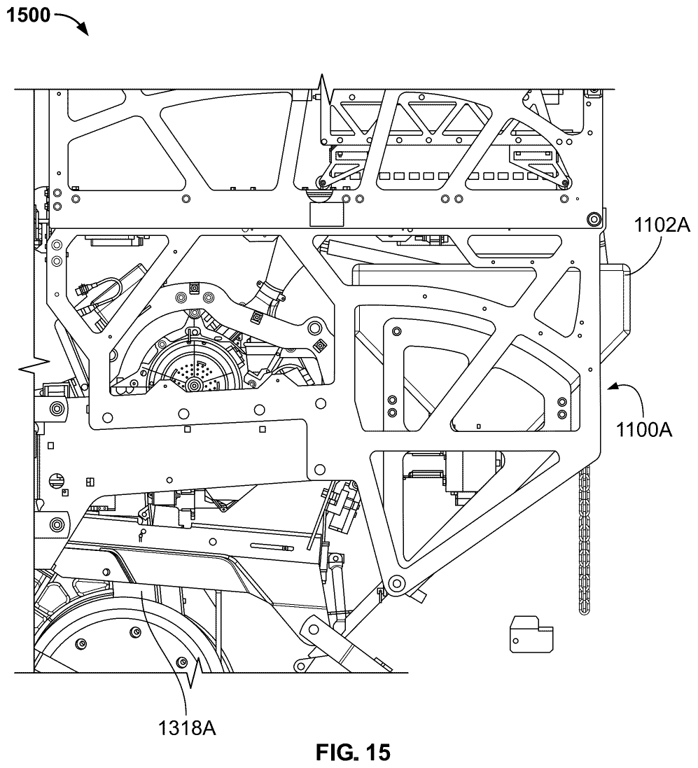

FIG. 15 illustrates another example embodiment of a planting unit 1500 including one or more aspects of the present disclosure. The planting unit 1500 may be employed as any one of the planting units 1206 of the planter 1200 in FIG. 12. The planting unit 1500 is substantially similar to the planting unit 1206 of FIGS. 12-14 but includes a treatment system 1100A. In the illustrated embodiment of FIG. 15, the treatment system 1100A is substantially similar to the treatment system 1100 of FIG. 11 but includes a different detachable container 1102A. The detachable container 1102A functions in a similar manner as the container 1102 of FIG. 11 but has a different shape (and therefore different storage volume) than the container 1102.

By employing the example treatment applicators, assemblies, and/or systems (and/or methods) herein (e.g., metering devices, etc.) with a rotating wheel or wheel assembly in a planter, treatment products such as such as microbials, insecticides, and inoculums may be prescriptively and accurately dispensed, for example, in a furrow created by the planter while planting seeds, to the soil independent of planting the seeds, etc. Additionally, rotation of the wheel or wheel assembly may be calibrated to ensure a desired flow rate of the treatment product into the furrow, to the soil, etc. As such, a desired amount of the dispensed treatment product may be positioned in the furrow near the planted seeds (which were previously dispensed in the furrow by the planter) before the planter subsequently closes the furrow, or to the soil, etc. For example, testing has shown that the treatment applicators, assemblies, and/or systems herein are able to dispense a treatment product with an error of about three percent (%) or less with regard to various flow rates and seed placements (e.g., at about +−2 seeds per foot, etc.), etc.

Additionally, the treatment applicators, assemblies, and/or systems (and/or methods) herein may include interchangeable components such as wheels, wheel assemblies, etc. As such, users can modify the treatment applicators, assemblies, and/or systems to include a particular rotating wheel or wheel assembly more suitable for a particular type of treatment product. As a result, one treatment applicator, assembly, and/or system may deposit many different types of treatment products. This allows users (e.g., scientists, etc.) to conduct different trials while planting, thereby reducing manpower, equipment, time, etc. required to conduct such trials.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An assembly for use in dispensing treatment products in a field, the assembly comprising:
an inlet configured to receive a treatment product;
an outlet configured to dispense the treatment product in the field; and
at least one wheel coupled between the inlet and the outlet, the at least one wheel including a base having an outer circumferential surface, and tabs spaced apart circumferentially from each other and extending away from the outer circumferential surface of the base, the tabs defining receptacles therebetween, each receptacle configured to receive a portion of the treatment product from the inlet as the at least one wheel rotates, the at least one wheel configured to transport the portion of the treatment product from the inlet and deliver the portion of the treatment product to the outlet, the outlet configured to dispense the portion of the treatment product in the field.

2. The assembly of claim 1, wherein the tabs extend radially away from the outer circumferential surface of the base, and wherein the tabs are evenly spaced apart circumferentially from each other.

3. The assembly of claim 1, wherein the at least one wheel includes multiple wheels coupled together, and wherein each of the wheels includes a base having an outer circumferential surface, and tabs spaced apart from each other and extending away from the outer circumferential surface of the base.

4. The assembly of claim 3, wherein the tabs of adjacent ones of the wheels are staggered; and
wherein the tabs of each of the wheels extend at an acute angle away from the outer circumferential surface of the base.

5. The assembly of claim 4, wherein the tabs of each of the wheels are flexible.

6. The assembly of claim 1, further comprising a housing configured to at least partially surround the at least one wheel.

7. The assembly of claim 6, wherein the housing defines a first channel extending between the inlet and the at least one wheel, and a second channel extending between the at least one wheel and the outlet.

8. The assembly of claim 1, further comprising an enclosure configured to at least partially surround the at least one wheel, the enclosure defining a first opening adjacent to the inlet and a second opening adjacent to the outlet.

9. The assembly of claim 8, further comprising a guard member coupled to the enclosure and aligned with the first opening, the guard member configured to inhibit debris from entering the at least one wheel.

10. The assembly of claim 8, further comprising an exit member coupled to the enclosure and aligned with the second opening, the exit member defining a funnel configured to receive the portion of the treatment product from the at least one wheel.

11. The assembly of claim 1, further comprising a motor configured to control rotation of the at least one wheel;
wherein the motor includes a shaft and wherein the base defines a channel extending therethrough and configured to receive the shaft.

12. The assembly of claim 1, further comprising a sensor adjacent to the outlet, the sensor configured to detect movement of the treatment product passing through the outlet.

13. The assembly of claim 1, further comprising a hopper adjacent to the inlet and configured to store the treatment product.

14. The assembly of claim 1, further comprising a detachable container adjacent to the inlet and configured to store the treatment product.

15. The assembly of claim 1, wherein the outlet is configured to dispense the treatment product into a furrow formed by a planter while planting the seeds; and
wherein the assembly further comprising an exit tube coupled to the outlet and extending into the furrow while planting, the exit tube configured to dispense the portion of the seed treatment product into the furrow adjacent to the at least one of the seeds.

16. A planter for planting seeds in a field, the planter comprising at least one planting unit including the assembly of claim 1.

17. A method of operating a treatment applicator to dispense treatment products in a field, the treatment applicator including at least one wheel defining a plurality of receptacles, the method comprising:
receiving, via an inlet, a treatment product in individual ones of the plurality of receptacles while the at least one wheel is rotating;
controlling rotation of the at least one wheel to transport the treatment product in the individual ones of the plurality of receptacles to an outlet located away from the inlet; and
delivering the treatment product in the individual ones of the plurality of receptacles to the outlet, thereby dispensing the treatment product in the field.

18. The method of claim 17, wherein the treatment applicator includes a housing defining a first channel extending between the inlet and the at least one wheel, and a second channel extending between the at least one wheel and the outlet, wherein receiving the treatment product in the individual ones of the plurality of receptacles includes receiving the treatment product in the individual ones of the plurality of receptacles after the treatment product passes through the first channel, and wherein delivering the treatment product to the outlet includes delivering the treatment product to the outlet after the treatment product passes through the second channel.

19. The method of claim 17, wherein the at least one wheel includes multiple staggered wheels coupled together, wherein each staggered wheel defines a plurality of receptacles offset from corresponding receptacles of adjacent wheels, and wherein controlling rotation of the at least one wheel includes controlling rotation of the multiple staggered wheels to transport the treatment product along sloping flow paths created by the offset receptacles of the staggered wheels to the outlet.

20. The method of claim 17, further comprising dispensing the treatment product to a furrow formed by a planter and adjacent to seeds while the planter plants the seeds.
